(19) United States
(12) Patent Application Publication
(10) Pub. No.: US 2026/0280258 A1
(43) Pub. Date: Sep. 17, 2026

(54) Fastening Device for Fastening a Component to a Vehicle Component in or on a Vehicle

(71) Applicant: Illinois Tool Works Inc., Glenview, IL (US)

(72) Inventors: Jan Müller, Würzburg (DE); Jörg Wagner, Kaiserslautern (DE); Hendrik Bobach, Hemmersheim (DE); Manuel Kellner, Alsfeld (DE)

(21) Appl. No.: 19/561,927

(22) Filed: Mar. 10, 2026

(30) Foreign Application Priority Data
Mar. 13, 2025 (DE) 10 2025 109 553.1
Jul. 3, 2025 (DE) 10 2025 126 054.0

(51) Int. Cl. H02G 3/32; B60R 16/02

(52) U.S. Cl. CPC H02G 3/32; B60R 16/0215

(57) ABSTRACT

A fastening apparatus secures a component such as a cable, cable harness, or power bus to a vehicle structure. The apparatus includes a holding device that attaches to the component and a connector device that links the holding device to the vehicle structure. The connector device forms a bearing connection with the holding device that allows limited movement. The movable connection accommodates thermal expansion and other dimensional changes between the component and the vehicle structure. By allowing controlled relative movement, the apparatus reduces mechanical stress and prevents tension caused by temperature variations while maintaining reliable attachment of the component.

### RELATED APPLICATIONS

The present application claims the benefit of German Patent Application Nos. 10 2025 109 553.1, filed Mar. 13, 2025, and 10 2025 126 054.0, filed Jul. 3, 2025, each titled “Fastening Device for Fastening a Component to a Vehicle Component in or on a Vehicle,” the contents of which are hereby incorporated by reference.

### BACKGROUND

A fastening apparatus of the type considered here is known at least in principle from the document DE 10 2018 006 870 A1.

This prior art relates to a fastening apparatus for attaching pipes to a vehicle, wherein the fastening apparatus should also in principle be suitable for attaching a cable or cable harness to a vehicle. The fastening apparatus known from this prior art is used to secure the component to be fastened, for example a pipe system or a cable harness, to a bottom region of the vehicle and thus to the vehicle.

For this purpose, the fastening apparatus comprises a holder with which respective length regions of the component to be fastened are over molded. The holder is thereby attached to the component to be fastened, such that the holder is fixed both in the longitudinal extension direction of the component to be fastened and in the radial direction of the component to be fastened. According to the teachings of document DE 10 2018 006 870 A1, this serves to avoid radial and axial relative movements between the component to be fastened and the holder.

Although the fastening apparatus known from DE 10 2018 006 870 A1 may in principle be suitable for attaching a cable harness to a corresponding vehicle component in or on a vehicle, the approach known from this prior art is, in practical use, particularly unsuitable for such an area of application. In particular, the fastening apparatus known from DE 10 2018 006 870 A1 is not suitable for attaching power buses to a corresponding vehicle component in or on a vehicle, since the fastening principle known from this prior art is designed for only low holding forces.

To provide electrical power to supply electric drives of vehicles, high-voltage storage devices, also known as drive batteries or accumulators, are known. Such drive batteries are typically powered by off-vehicle charging stations to make this energy available for operation of the vehicle. In particular, power buses are used to guide electrical energy within the vehicle, which comprise conduits for power routing and/or data transmission.

Mounts are typically necessary for mounting particularly rigid power buses in electrically driven vehicles in order to secure them relative to the vehicle. Due to manufacturing tolerances and temperature expansions, movement compensation, in the translational direction, should be enabled in the region of the connection or fastening. Relative movements should in particular not occur between the mount and the power bus in order to prevent wear on the power bus or conduit.

### SUMMARY OF THE DISCLOSURE

The present disclosure relates generally to a fastening apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, the exemplary embodiment of the fastening apparatus according to the disclosure.

FIG. 2 illustrates schematically and in a plan view, the example embodiment of the fastening apparatus according to the disclosure.

FIG. 3 illustrates schematically and in an isometric view, the bearing block region used in the exemplary embodiment of the fastening apparatus of the disclosure with the articulated connector region of the bearing part.

FIG. 4 illustrates schematically and in an isometric view, a region of the holding device with the connected connector device, in the exemplary embodiment of the fastening apparatus according to the disclosure.

FIG. 5 illustrates schematically and in an isometric view, a region of the holding device with the connected connector device in another exemplary embodiment of the fastening apparatus of the disclosure.

FIG. 6 illustrates schematically and in a sectional view, the region of the holding device with the connected connector device in the further exemplary embodiment of the fastening apparatus according to the disclosure according to FIG. 5.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to a fastening apparatus for fastening a component to a vehicle component in or on a vehicle.

Specifically, the disclosure relates to a fastening apparatus for a cable, for a cable harness, or for a power bus in a vehicle, in particular in an e-vehicle or in a hybrid vehicle.

An object of the present disclosure is thus to specify a fastening apparatus, wherein the fastening apparatus is also suitable for fastening power buses to a vehicle component in or on a vehicle, and wherein a movement compensation between the power bus to be fastened and a corresponding connection point in the vehicle is ensured.

Accordingly, the disclosure relates in particular to a fastening apparatus for fastening a component, in particular in the form of a cable, a cable harness, or a power bus, to a vehicle component in or on a vehicle. The fastening apparatus comprises a holding device to which the component to be fastened, i.e., the cable, the cable harness, or the power bus, is connected or connectable. Moreover, the fastening apparatus according to the disclosure comprises a connector device, which is or can be connected to the vehicle component on the one hand and to the holding device on the other hand.

According to the disclosure, it is provided in particular that, in particular for the purpose of avoiding thermally caused tension, the connector device is connected at least to the holding device via a bearing that may be floating, as needed.

The advantages achievable with the solution according to the disclosure are obvious: In contrast to the approach proposed in document DE 10 2018 006 870 A1, radial and/or axial relative movement between the component to be fastened, i.e., in particular between the power bus and the vehicle component is deliberately permitted, so that, in particular thermally caused tension is equalized by the fastening apparatus. Such equalization of particularly thermally caused tension is realized by the as-needed floating bearing. This is particularly necessary if power buses or the like are to be attached to the vehicle component with the fastening apparatus according to the disclosure. In particular, a power bus of the type considered herein is a channel which can comprise and bundle live lines or lines for signal transmission. For example, such a power bus within a vehicle may form a connection between an interface to an external charging station and an energy storage device of the vehicle. In particular, a power bus may be a high-voltage charging rail for a vehicle driven at least in part electrically.

Such power buses may experience changes in temperature during operation and thus thermal expansions, which can be at least partially compensated for by means of the as-needed floating bearing provided by the fastening apparatus according to the disclosure.

In addition, power buses have manufacturing tolerances that could lead to stresses, for example in the area of a live contact, without a possibility of movement compensation. Such a possibility for movement compensation can be provided by means of the at least as-needed floating bearing of the fastening apparatus according to the disclosure proposed herein.

The fastening apparatus according to the disclosure comprises essentially two components, namely, on the one hand, a holding device with which the component to be fastened, for example the power bus, is connected or connectable. The holding device thus assumes the function of a fastening element. On the other hand, the fastening apparatus according to the disclosure comprises a connector device, which represents the interface between the component to be fastened and the holding device, to which the component to be fastened is connected, and the vehicle component.

In particular, the as-needed floating bearing of the fastening apparatus according to the disclosure is configured such that, at least as needed, the holding device can be rotated relative to the connector device about an axis of rotation.

Advantageously, the as-needed floating bearing of the fastening apparatus according to the disclosure is further configured such that, as needed, the holding device can be moved relative to the connector device, at least via a predetermined or predeterminable distance, translationally in a first direction extending perpendicular to the axis of rotation.

It is of further advantage that the as-needed floating bearing of the fastening apparatus according to the disclosure is configured such that the holding device can be moved relative to the connector device, at least via a predetermined or predeterminable distance, translationally in a second direction extending perpendicular to the axis of rotation and to the first direction, respectively.

In this case, preferably the as-needed floating bearing should be configured such that the holding device is connected to the connector device in a rotational-resistant and/or shear-resistant manner for as long as a predetermined or specifiable critical torque, in particular a torque, in particular due to a thermally caused expansion of the component connected to the holding device, acts on the holding device. Upon or after exceeding the critical torque, in particular torque, acting on the holding device, the connection between the holding device and the connector device should reversibly transition to a state that is at least substantially rotationally-elastic and/or shear-elastic.

Preferably the holding device is connected to a connector device via two bearing regions positioned opposite one another, in each case via a bearing of the aforementioned type which may be floating, as needed.

According to preferred embodiments of the fastening apparatus according to the disclosure, it is provided that the as-needed floating bearing is formed by an in particular pocket-shaped housing part and by an in particular disc-shaped or plate-shaped bearing part, at least partially or regionally received in the in particular pocket-shaped housing part. The in particular pocket-shaped housing part of the as-needed floating bearing is preferably fixedly connected to the holding device and in particular integrally formed with the holding device.

On the other hand, the in particular disc-shaped or plate-shaped bearing part of the as-needed floating bearing of the fastening apparatus according to the disclosure is at least partially or regionally received in the in particular pocket-shaped housing part.

In this context, it is advantageous if the in particular disc-shaped or plate-shaped bearing part is connected to an in particular bar-shaped or bar-like connector region, which is guided out of the in particular pocket-shaped housing part via a window region formed in a wall of the in particular pocket-shaped housing part.

In design variants of the previously preferred implementation of the fastening apparatus according to the disclosure, it is provided that the in particular disc-shaped or plate-shaped bearing part, on the one hand, and the in particular pocket-shaped housing part, on the other hand, are designed such that the in particular disc-shaped or plate-shaped bearing part is received or receivable with an interference fit in the in particular pocket-shaped housing part.

This interference fit is in particular selected such that the holding device with the in particular pocket-shaped housing part is rotatable relative to the in particular disc-shaped or plate-shaped bearing part, namely when a, in particular thermally caused, critical torque acts on the holding device.

Alternatively or additionally, the interference fit is preferably selected in such a way that the holding device, which, with the in particular pocket-shaped housing part, is translationally movable relative to the in particular disc-shaped or plate-shaped bearing part in the first direction and/or in the second direction, is movable in particular when a, in particular thermally caused, critical torque, in particular a shear moment, acts on the holding device.

Preferably a longitudinal extension direction of the in particular bar-shaped or bar-like connector region should match the axis of rotation about which the holding device can be rotated relative to the connector device.

In particular for the purpose of simplified installation of the fastening apparatus, it is provided according to the design variants of the disclosure that in a wall region of the in particular pocket-shaped housing part abutting the wall region in which the window region is configured, an opening is configured via which the in particular disc-shaped or plate-shaped bearing part can be inserted, and in particular can be stuck, into the in particular pocket-shaped housing part. Of course, other design variants can also be considered here in this regard.

In order to enable as optimum an equalization of any, in particular thermally caused, tension as possible, it is provided in design variants of the fastening apparatus according to the disclosure that the in particular bar-shaped or bar-like connector region is connected or connectable to a bearing block region connected or connectable to the vehicle component.

It is also conceivable in this context that the bearing block region is configured such that the in particular bar-shaped or bar-like connector region can preferably be moved in a guided manner relative to the bearing block region.

Various design variants are possible with regard to the bearing block region. In this context, in particular, it is conceivable that at an end region of the in particular bar-shaped or bar-like connector region positioned opposite the disc-shaped or plate-shaped bearing part, the connector region comprises a pivot head which is at least partially or regionally accommodated in a socket of the bearing block region which is in particular designed so as to be complementary to the pivot head.

According to preferred design variants, in particular of the most recently mentioned aspect of the present disclosure, it is provided that the pivot head has a shape that is at least substantially spherical.

Alternatively, however, it is also conceivable that the pivot head has a shape that is at least substantially circular cylinder-like, with a cylinder longitudinal axis that extends at least substantially parallel to the longitudinal extension direction of the region of the component to be fastened via which the component to be fastened is connected to the holding device of the fastening apparatus.

With regard to the holding device of the fastening apparatus according to the disclosure, it is provided in conceivable embodiments of the disclosure that the holding device comprises an in particular frame-shaped holding body in which the component to be fastened is received or receivable at least partially or regionally. In this context, in particular, it is conceivable the in particular frame-like holding body should be configured so as to accommodate the component to be fastened in a clearance-free manner.

In principle, it is generally conceivable in this context that the in particular frame-like holding body of the holding device preferably comprises two identically constructed frame parts, which, for the purpose of forming the frame-like holding body, can be connected or connectable to one another via an in particular detachable connection, in particular a spring clamp connection.

The exemplary embodiment of the fastening apparatus 1 of the disclosure shown in the drawings is for mounting power buses (not shown in the drawings) to a vehicle component 100 in a vehicle.

For this purpose, the fastening apparatus 1 comprises a holding device 2 with which the power buses to be fastened can be connected.

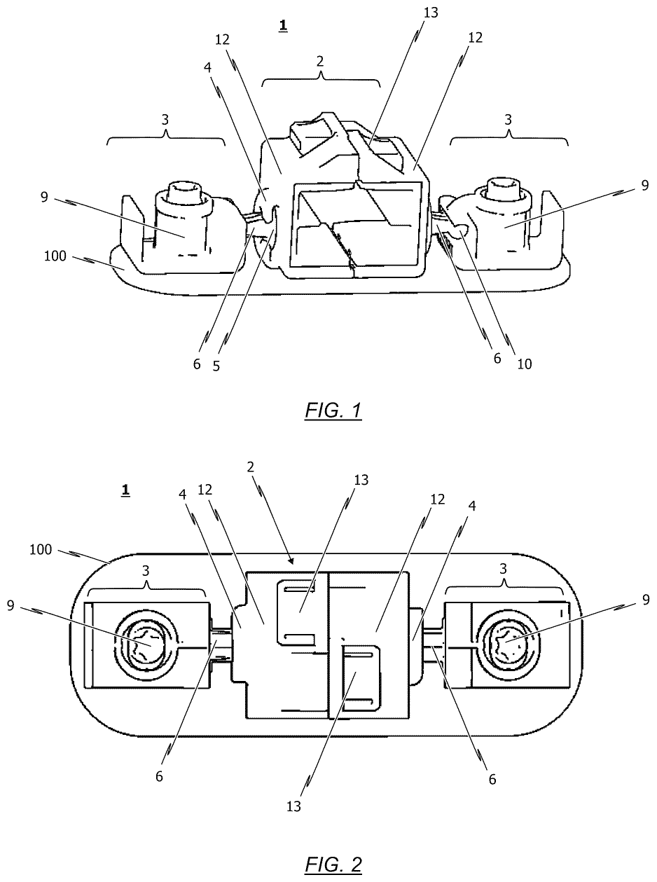

As can be seen in particular from the illustration in FIG. 1 or the plan view in FIG. 2, in the exemplary embodiment of the fastening apparatus 1 according to the disclosure, it is provided that the holding device 2 comprises a frame-shaped holding body in which the power buses to be fastened can be received at least partially or regionally.

In particular, the frame-shaped holding body is designed to be complementary to the power buses to be connected in order to be able to receive the power buses to be connected in a clearance-free manner.

It can further be seen in the drawings that the frame-shaped holding body of the holding device 2 comprises two identically designed frame parts 12, which are releasably connected to one another via a spring clamp connection 13 to form the frame-shaped holding body.

In addition to the holding device 2, the exemplary embodiment of the fastening apparatus 1 according to the disclosure comprises a connector device 3, which is connected, on the one hand, to the vehicle component 100, and on the other hand, to the holding device 2. The connector device 3 is wherein, for the purpose of avoiding thermally caused tension, it is at least connected to the holding device 2 via an as-needed floating bearing.

The as-needed floating bearing is hereby configured such that, at least as needed, the holding device 2 can be rotated relative to the connector device 3 about an axis of rotation.

In particular, the as-needed floating bearing is configured such that, as needed, the holding device 2 can be moved relative to the connector device 3, at least via a predetermined or predeterminable distance, translationally in a first direction extending perpendicular to the axis of rotation. The as-needed floating bearing is further configured such that the holding device 2 can be moved relative to the connector device 3, at least via a predetermined or predeterminable distance, translationally in a second direction extending perpendicular to the axis of rotation and to the first direction, respectively.

In particular, the as-needed floating bearing is configured such that the holding device 2 is connected to the connector device 3 in a non-rotational and/or shear-resistant manner until a predetermined or predeterminable critical torque, in particular due to a thermally caused expansion of the power buses connected to the holding device 2, acts on the holding device 2. Upon or after exceeding the critical torque acting on the holding device 2, the connection between the holding device 2 and the connector device 3 thus reversibly transitions to a state that is at least substantially rotationally-elastic and/or shear-elastic.

The illustrations in FIG. 1 and FIG. 2 show that the holding device 2 of the exemplary embodiment of the fastening apparatus 1 according to the disclosure is connected to a connector device 3 via two mutually opposite bearing regions, each via an as-needed floating bearing.

In the exemplary embodiment of the fastening apparatus 1 according to the disclosure shown in the drawings, it is provided for forming the as-needed floating bearing that this bearing is formed by a pocket-shaped housing part 4, which is fixedly connected to the holding device 2, and by a disc-shaped or plate-shaped bearing part 5, which is received at least partially or regionally in the pocket-shaped housing part 4.

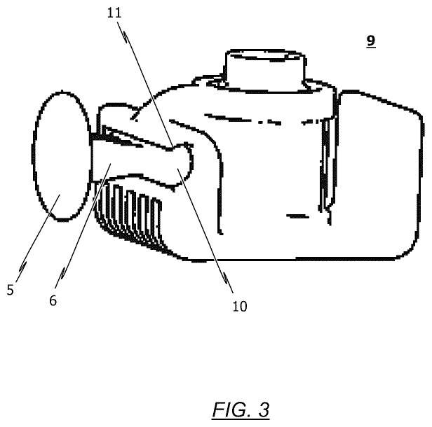

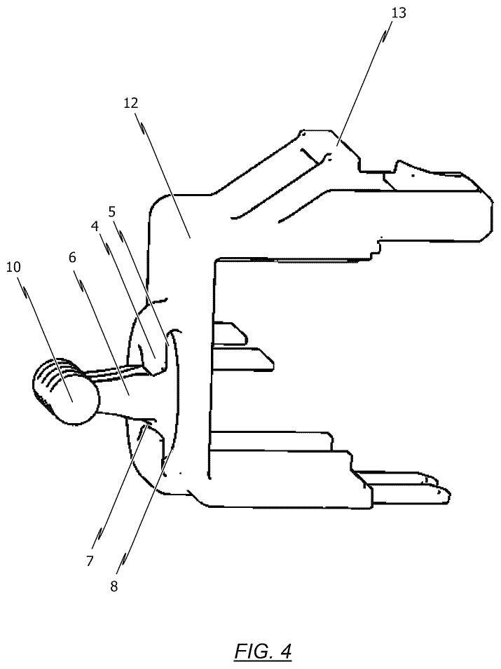

For example, as can be seen from the illustrations in FIG. 3 and FIG. 4, the disc-shaped or plate-shaped bearing part 5 is connected to a bar-shaped or bar-like connector region 6. It can be seen in FIG. 1 that the bar-shaped or bar-like connector region 6 is guided out of the pocket-shaped housing part 4 via a window region 7 embodied in a wall of the pocket-shaped housing part 4.

The disc-shaped or plate-shaped bearing part 5, on the one hand, and the pocket-shaped housing part 4, on the other hand, are configured such that the disc-shaped or plate-shaped bearing part 5 is received or receivable into the pocket-shaped housing part 4 with an interference fit.

The interference fit is preferably selected such that the holding device 2 can only be rotated with the pocket-shaped housing part 4 relative to the disc-shaped or plate-shaped bearing part 5 when a, in particular thermally caused, critical torque acts on the holding device 2.

Furthermore, the disc-shaped or plate-shaped bearing part 5 on the one hand and the pocket-shaped housing part 4 on the other hand are configured in such a way that the disc-shaped or plate-shaped bearing part 5 is or can be accommodated with an interference fit in the pocket-shaped housing part 4, wherein the holding device 2 can be moved with the pocket-shaped housing part 4 translationally relative to the disc-shaped or plate-shaped bearing part 5 in the first direction and/or in the second direction, namely when a thermally caused critical torque, in particular shear moment, influences the holding device 2.

In the exemplary embodiment of the fastening apparatus 1 according to the disclosure shown in the drawings, the axis of rotation about which the holding device 2 is rotatable relative to the connector device 3 matches a longitudinal extension direction of the bar-shaped or bar-like connector region 6.

It can further be seen in the illustration in FIG. 1 that, in a wall region of the pocket-shaped housing part 4 abutting the wall region in which the window region 7 is configured, an opening 8 is configured via which the disc-shaped or plate-shaped bearing part 5 can be inserted, and in particular can be stuck, into the pocket-shaped housing part 4.

The bar-shaped or bar-like connector region 6 is connected to a bearing block region 9 that is connected to the vehicle component 100. The bearing block region 9 is configured such that the bar-shaped or bar-like connector region 6 can preferably be moved in a guided manner relative to the bearing block region 9.

For this purpose, in the exemplary embodiment of the fastening apparatus 1 according to the disclosure shown in the drawings, it is provided that, at an end region of the bar-shaped or bar-like connector region 6 opposite the disc-shaped or plate-shaped bearing part 5, this has a pivot head 10 which is movable at least partially or regionally in a socket 11 of the bearing block region 9 that is designed to be complementary to the pivot head 10.

In the exemplary embodiment of the fastening apparatus 1 according to the disclosure shown in the drawings, it is provided that the pivot head 10 has a shape at least substantially similar to a circular cylinder-like with a longitudinal axis of the cylinder that is at least substantially parallel to the direction of longitudinal extension of a region of the power buses via which the power buses are connected to the holding device 2.

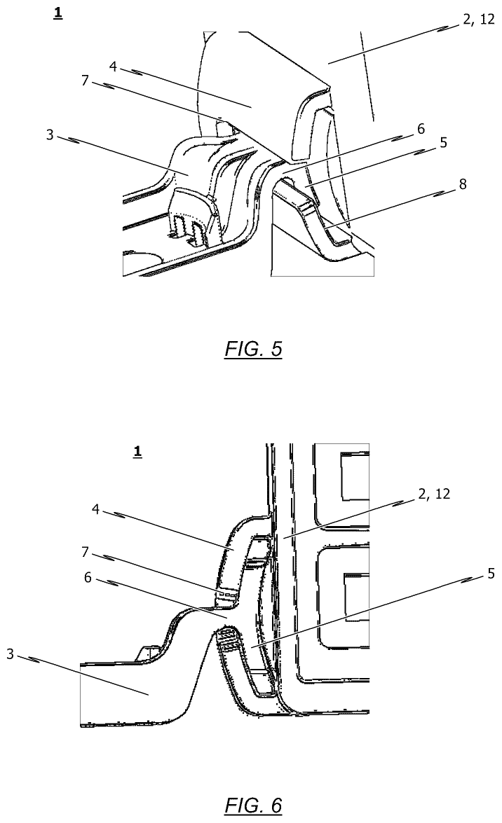

Referring to the illustrations in FIG. 5 and FIG. 6, a further exemplary embodiment of the fastening apparatus 1 according to the disclosure is described in detail below.

Like the embodiment of the fastening apparatus 1 according to the disclosure previously described with reference to the illustrations in FIG. 1 to FIG. 4, the alternative embodiment shown in FIG. 5 and FIG. 6 comprises a holding device 2, to which a component to be fastened is connected or connectable, as well as a connector device 3, which is connected or connectable, on the one hand, to the vehicle component, and on the other hand, to the holding device 2.

In addition, the connector device 3 is configured to avoid thermally caused tension. For this purpose, the connector device 3 is connected to the holding device 2 via an as-needed floating bearing.

In contrast to the first exemplary embodiment of the fastening apparatus 1 according to the disclosure according to FIG. 1 to FIG. 4, in the second exemplary embodiment according to FIG. 5 and FIG. 6, however, the floating bearing is not configured such that the holding device 2 is rotatable relative to the connector device 3 at least as needed about an axis of rotation. In other words, the exemplary embodiment of the fastening apparatus 1 according to the present disclosure shown in FIG. 5 and FIG. 6 does not guarantee separate angular compensation.

However, the floating bearing of the second exemplary embodiment of the fastening apparatus 1 according to the disclosure according to FIG. 5 and FIG. 6 is also configured such that the holding device 2 is translationally movable relative to the connector device 3, as needed, at least over a predetermined or predeterminable distance of travel. In particular, the as-needed floating bearing is configured such that the holding device 2 is connected to the connector device 3 in a shear-resistant manner until a predetermined or predeterminable critical torque influences the holding device 2, in particular due to a thermally caused expansion of the component connected to the holding device 2, wherein, after or upon exceeding the critical torque acting on the holding device 2, the connection between the holding device 2 and the connector device 3 reversibly transitions into a state that is at least substantially shear-elastic.

In particular, the sectional view according to FIG. 6 shows that the floating bearing is formed by a pocket-shaped housing part 4 and by a disc-shaped or plate-shaped bearing part 5, which is received at least partially or regionally in the pocket-shaped housing part 4, wherein the pocket-shaped housing part 4 is fixedly connected to the holding device 2. The disc-shaped or plate-shaped bearing part 5 is connected to a bar-shaped or bar-like connector region 6, which is guided out of the pocket-shaped housing part 4 via a window region 7 formed in a wall of the pocket-shaped housing part 4.

It is provided that the disc-shaped or plate-shaped bearing part 5, on the one hand, and the pocket-shaped housing part 4, on the other hand, are designed such that the disc-shaped or plate-shaped bearing part 5 is accommodated in the pocket-shaped housing part 4 with an interference fit.

The isometric view according to FIG. 5 shows that, in a wall region of the in particular pocket-shaped housing part 4 abutting the wall region in which the window region 7 is configured, an opening (8) is configured via which the disc-shaped or plate-shaped bearing part 5 can be inserted, and in particular can be stuck, into the pocket-shaped housing part 4.

In contrast to the exemplary embodiment of the fastening apparatus 1 according to FIG. 1 to FIG. 4, in the design variant according to FIG. 5 and FIG. 6, the bar-shaped or bar-like connector region 6 is directly connected to the vehicle component, and not via an additional bearing block region, which allows further angular compensation as in the first exemplary embodiment according to FIG. 1 to FIG. 4.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### List of Reference Numerals

1 Fastening apparatus
2 Holding device
3 Connector device
4 Pocket-shaped housing part
5 Disc-shaped or plate-shaped bearing part
6 Bar-shaped or bar-like connector region
7 Window region
8 Opening
9 Bearing block region
10 Pivot head
11 Socket
12 Frame part
13 Spring clamp connection
100 Vehicle component

What is claimed is:

1. A fastening apparatus (1) for fastening a component, in the form of a cable, a cable harness, or a power bus, to a vehicle component (100) in or on a vehicle, wherein the fastening apparatus (1) comprises the following:
a holding device (2) to which the component to be fastened is or can be connected; and
a connector device (3), which is or can be connected to the vehicle component (100) on the one hand and to the holding device (2) on the other hand,
wherein, for the purpose of avoiding thermally caused tension, the connector device (3) is connected at least to the holding device (2) via a bearing that may be floating, as needed.

2. The fastening apparatus (1) according to claim 1,
wherein the as-needed floating bearing is configured such that, at least as needed, the holding device (2) can be rotated relative to the connector device (3) about an axis of rotation.

3. The fastening apparatus (1) according to claim 2,
wherein the as-needed floating bearing is configured such that, as needed, the holding device (2) can be moved relative to the connector device (3), at least via a predetermined or predeterminable distance, translationally in a first direction extending perpendicular to the axis of rotation.

4. The fastening apparatus (1) according to claim 3,
wherein the as-needed floating bearing is configured such that the holding device (2) can be moved relative to the connector device (3), at least via a predetermined or predeterminable distance, translationally in a second direction extending perpendicular to the axis of rotation and to the first direction, respectively.

5. The fastening apparatus (1) according to claim 1,
wherein the as-needed floating bearing is configured such that the holding device (2) is connected to the connector device (3) in a rotation-resistant and/or shear-resistant manner until a predetermined or predeterminable critical torque influences the holding device (2) due to a thermally caused expansion of the component connected to the holding device (2), wherein, upon or after exceeding the critical torque, the connection between the holding device (2) and the connector device (3) reversibly transitions into a state that is at least substantially rotation-elastic and/or shear-elastic.

6. The fastening apparatus (1) according to claim 1,
wherein the holding device (2) is connected to a connector device (3) via two bearing regions positioned opposite one another, in each case via a bearing which may be floating, as needed.

7. The fastening apparatus (1) according to claim 1,
wherein the as-needed floating bearing is formed by a pocket-shaped housing part (4), which is preferably fixedly connected to the holding device (2) and is configured integrally with the holding device (2), and by a disc-shaped or plate-shaped bearing part (5) which is at least partially or regionally accommodated in the pocket-shaped housing part (4), wherein the disc-shaped or plate-shaped bearing part (5) is connected to an bar-shaped or bar-like connector region (6), which is guided out of the pocket-shaped housing part (4) via a window region (7) configured in a wall of the pocket-shaped housing part (4).

8. The fastening apparatus (1) according to claim 7,
wherein the disc-shaped or plate-shaped bearing part (5) on the one hand and the pocket-shaped housing part (4) on the other hand are configured in such a way that the disc-shaped or plate-shaped bearing part (5) is or can be accommodated with an interference fit in the pocket-shaped housing part (4), in such a way that the holding device (2) can be rotated with the pocket-shaped housing part (4) relative to the disc-shaped or plate-shaped bearing part (5), when a thermally caused critical moment of rotation influences the holding device (2).

9. The fastening apparatus (1) according to claim 7, wherein the disc-shaped or plate-shaped bearing part (5) on the one hand and the pocket-shaped housing part (4) on the other hand are configured in such a way that the disc-shaped or plate-shaped bearing part (5) is or can be accommodated with an interference fit in the pocket-shaped housing part (4), in such a way that the holding device (2) can be moved with the pocket-shaped housing part (4) translationally relative to the disc-shaped or plate-shaped bearing part (5) in the first direction and/or in the second direction, when a thermally caused critical torque, shear moment, influences the holding device (2).

10. The fastening apparatus (1) according to claim 7,
wherein a longitudinal extension direction of the bar-shaped or bar-like connector region (6) matches the axis of rotation about which the holding device (2) can be rotated relative to the connector device (3).

11. The fastening apparatus (1) according to claim 7,
wherein, in a wall region of the pocket-shaped housing part (4) abutting the wall region in which the window region (7) is configured, an opening (8) is configured via which the disc-shaped or plate-shaped bearing part (5) can be inserted, and can be stuck, into the pocket-shaped housing part (4).

12. The fastening apparatus (1) according to claim 7,
wherein the bar-shaped or bar-like connector region (6) is or can be connected to a bearing block region (9) that is or can be connected to the vehicle component (100).

13. The fastening apparatus (1) according to claim 12,
wherein the bearing block region (9) is configured such that the bar-shaped or bar-like connector region (6) can preferably be moved in a guided manner relative to the bearing block region (9).

14. The fastening apparatus (1) according to claim 12, wherein, at an end region of the bar-shaped or bar-like connector region (6) positioned opposite the disc-shaped or plate-shaped bearing part (5), this connector region comprises a pivot head (10) which is at least partially or regionally accommodated in a socket (11) of the bearing block region (9) which is designed so as to be complementary to the pivot head (10).

15. The fastening apparatus (1) according to claim 14,
wherein the pivot head (10) has an at least substantially sphere-like shape; or
wherein the pivot head (10) has a shape that is at least substantially circular cylinder-like, with a cylinder longitudinal axis that extends at least substantially parallel to the longitudinal extension direction of the region of the component via which the component is connected to the holding device (2).

16. The fastening apparatus (1) according to claim 1,
wherein the holding device (2) comprises an frame-like holding body in which the component to be fastened is or can be received at least partially or regionally.

17. The fastening apparatus (1) according to claim 16,
wherein the frame-like holding body is configured so as to accommodate the component to be fastened in a clearance-free manner.

18. The fastening apparatus (1) according to claim 16,
wherein the frame-like holding body preferably comprises two identically constructed frame parts (12), which, for the purpose of forming the frame-like holding body, can be connected to one another via an detachable connection, a spring clamp connection (13).
